(19) United States
(12) Patent Application Publication
(10) Pub. No.: US 2010/0094793 A1
(43) Pub. Date: Apr. 15, 2010

(54) PRODUCT DESCRIPTION TRANSFORMATION METHODS AND SYSTEMS

(75) Inventors: Kirk John Ocke, Ontario, NY (US); Michael David Shepherd, Ontario, NY (US); Dale Ellen Gaucas, Rochester, NY (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/248,432

(22) Filed: Oct. 9, 2008

(51) Int. Cl. G06N 5/02

(52) U.S. Cl. 706/47

(57) ABSTRACT

Systems and methods for product description transformation use information about a specific Target Workflow that will be used to execute a job (Process Network), such as print job in a print shop. A knowledge/rule based system can mine facts from the Target Workflow and evaluate those facts using a knowledge base that will infer constraints and other information to be used during the actual transformation step. Differences between what is specified in a Product Description, such as a JDF Intent, and a Target Workflow can be reconciled to produce a workflow to manufacture a product. This information about the Target Workflow along with the information it uses from the JDF Intent (Product Description) is used to produce a Process Network (Workflow Plan/job) consistent with the JDF Intent and Target Workflow.

### TECHNICAL FIELD

The presently disclosed embodiments generally relate to product descriptions and also relate to process workflows. More particularly, the present disclosed embodiments relate to systems and methods for transforming product descriptions, particularly product descriptions of print products, such as books, into an appropriate process workflow required to create a desired end product.

### BACKGROUND

In workflow automation systems, the description of a product is in a vocabulary specific to the nature of the product, whereas the description of the steps required to create the product are in a vocabulary or several vocabularies specific to the processes involved in creating the various components of the product. Translation of the Product Description into a detailed set of processing instruction is done manually and can be time consuming. Manual translation depends heavily on individual expertise, thereby creating a scarce resource, e.g., an expert whose job it is to translate Product Descriptions into processing instruction. For low-margin, quick turn-around business such as that conducted by print shops, manual tasks requiring extensive human expertise are significant factors in the cost of creating the end product.

Workflow automation systems can transform a Product Description into a Process Network, for example a workflow automation system can transform JDF Product intent description into a JDF Process Network. The conversion uses information provided in the Product Description to completely parameterize a Workflow Plan (job) to manufacture the desired product. The system first classifies a Product Description, such as a JDF Intent, into a predefined product type known by the system such as a “Booklet” or “Business Card”. A Workflow Plan template is then selected for the given product type. For example, in the case of a “Booklet” a pre-defined Workflow Plan template is loaded that consists of an Imposition step (with signature-booklet imposition) followed by a Printing step. This Workflow Plan template is then parameterized (i.e., all the details are filled in) using a forward chaining rules-based implementation that depends on information from the JDF Intent Product Description. Not only are the essential/required processing steps defined in the Workflow Plan template parameterized, but additional processing steps may also be added such as Format Conversion or PDF Combine (document concatenation), and subsequently parameterized.

### BRIEF SUMMARY

According to one aspect, there is provided a system for transforming a Product Description into a Process Network specifying how to create a product. A common Classification System can link Product Descriptions and processing instructions required to create a product. At least one predefined Workflow Template can comprise partially completed Process Network specifications for creating a product. A Target Workflow can comprise partially or fully specified Process Network specifications for creating a product.

The system can have a Knowledge/Rule Based System, wherein the Knowledge/Rule Base System is configured to classify at least one Product Description into a product class in the common classification system, collect facts from the classified Product Description, Workflow Template and Target Workflow; generate an Initial Workflow Plan from the collected facts by analyzing and resolving any conflicts between the collected Product Description, Workflow Template and Target Workflow facts; and transform the Initial Workflow Plan into a Process Network specifying how to create at least part of the product defined by the Product Description that is consistent with the Target Workflow.

According to yet another aspect, there is provided a method for transforming Product Descriptions into a Process Network specifying how to create a product. A Product Description can be classified into in at least one class within a System of Classification. A Workflow Template can be selected for the at least one class that represents the Product Description. A Target Workflow can be provided. Facts from the Product Description, Workflow Template and Target Workflow can be collected. An Initial Workflow Plan can be generated from the collected facts using a Knowledge/Rule Base System. The Knowledge/Rule Base System can generate the Initial Workflow Template by analyzing, and resolving any conflicts between, the Product Description, Workflow Template and Target Workflow facts. The Knowledge/Rule Base System, using the collected facts, can transform the Initial Workflow Plan into a Process Network specifying how to create at least part of the product defined by the Product Description that is consistent with the Target Workflow.

According to another aspect, there is provided a computer program product comprising: a computer-usable data carrier storing instructions that, when executed by a computer, cause the computer to perform a method comprising a method for transforming Product Descriptions into a Process Network specifying how to create a product, comprising classifying a Product Description in at least one class within a System of Classification; selecting a Workflow Template for the at least one class that represents the Product Description; providing a Target Workflow collecting facts from the Product Description, Workflow Template and Target Workflow; generating an Initial Workflow Plan from the collected facts using a Knowledge/Rule Base System; the Knowledge/Rule Based System analyzing, and resolving any conflicts between, the Product Description, Workflow Template and Target Workflow facts in order to generate the Initial Workflow Plan; transforming, using the Knowledge/Rule Base System and the collected facts, the Initial Workflow Plan into a Process Network specifying how to create at least part of the product defined by the Product Description that is consistent with the Target Workflow.

### BRIEF DESCRIPTION OF THE DRAWINGS

The accompanying figures, in which like reference numerals refer to identical or functionally-similar elements throughout the separate views and which are incorporated in and form part of the specification, further illustrate the embodiments.

FIG. 1 illustrates components of an exemplary workflow automation system which enables creation, modification and execution of workflows;

FIG. 2 illustrates a block diagram illustrating modules and operations thereof for carrying out features of embodiments in a workflow automated system, such as for example the system of FIG. 1;

FIG. 3 illustrates a sample product classification and template; and

FIG. 4 illustrates a flow diagram of process steps in accordance with features of the embodiments.

### DETAILED DESCRIPTION

The particular definitions, values and configurations discussed in these non-limiting examples can be varied and are cited merely to illustrate an embodiment and are not intended to limit the scope of the embodiments.

Definitions:
Workflow Template: A Workflow partially populated with Processing Instructions.
Fully Parameterized Workflow Plan: A Workflow Plan for which all the required information to execute the plan is known.
JDF (Job Definition Format): JDF is a comprehensive XML-based file format for end-to-end job ticket specification within a print shop.
JDF Intent: A subset of JDF that allows a product to be described using a formalized set of structures and vocabulary.
JDF Process: JDF Process represents a Workflow Plan. Specifically, JDF Process provides a way to describe a Workflow Plan in a print shop.
Knowledge/Rule-based system: Uses asserted facts and rules that fire based on the facts to infer some conclusion.
Pre-defined Product Type: A Product Type that is deployed with and known to the Workflow Automation System.
Pre-defined Workflow: A pre-defined collection of steps (actions) that when executed produce a desired result. A workflow typically requires external input of some form. In a print shop a workflow typically consist of the pre-press, press (printing) and post-press processing steps to create a print related product. Each individual step in a workflow may have default or required parameters associated with that step.
Processing Instructions: Instructions sufficient to execute a particular process. An example of processing instructions is the Process Node construct in JDF.
Process Network: A set of processing instructions that when executed in the order specified by the Process Network result is a product. A Process Network is synonymous with a Workflow Plan (see below).
Product Description: A product described using a formal unambiguous vocabulary. An example of a Product Description vocabulary is the Product Node in JDF.
Product Type: One of the many print related product types that can be produced by a print shop. For-example: Business Card, Booklet, Perfect Bound Book . . .
Target Workflow: A Pre-defined Workflow, identified when a job is submitted, as the workflow to use for this job.
Vocabulary: specific language for communicating between product and process.
Workflow Automation System: A system that allows the creation, modification and automated execution of workflows.
Workflow Plan: An organized collection of parameterized steps (actions) the execution of which results in the realization of some goal. Specifically in a print shop a Workflow Plan defines all the steps and parameters to manufacture a print related product or some aspect of a print related product.
Workflow Step: An atomic step in a Workflow Plan.

The system and methods described in this application can be implemented to enable a Product Description sent to a specific automation system workflow to be transformed into a Process Network that is more likely to be consistent with the user's expectations.

A knowledge/rule based system can mine facts from the Target Workflow and evaluate those facts using a knowledge base that will infer constraints and other information to be used during the actual transformation step. The knowledge rule-based system can reconcile differences between what is specified in a Product Description (JDF Intent) and a Target Workflow in order to produce a workflow to manufacture a print product or other product defined by the Product Description. The knowledge/rule base system can use this information about the Target Workflow along with the information it uses from the JDF Intent (Product Description) to produce a Process Network (Workflow Plan/job) consistent with the JDF Intent and Target Workflow or possibly determine that such a Process Network cannot be created.

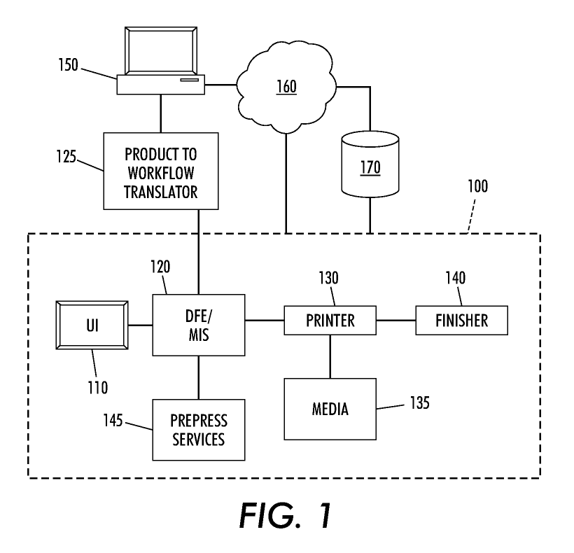

Referring to FIG. 1 of the accompanying drawings, components of a printing system 100 that includes a workflow automation system that can be utilized in accordance with carrying out the embodiments is illustrated. A typical printing system includes a user interface 110, a digital front end (DFE) 120, and a print engine 130. In this particular example, the workflow automation system can be implemented on the DFE or MIS 120 in conjunction with user interface 110 or work station 150. The DFE or MIS 120 includes access to modules 125 to assist with product to workflow translation, typically embodied in software, and also enables image processing and control function. Various prepress services 145 may optionally be invoked from the MIS or other print job controller. The print engine 130 has access to media 135 of various size and cost. A finisher 140 operates after a job is printed by the print engine 130 to manage arrangement of the print job, which can include sorting, cutting and stapling functions. A user can access and operate the printing system 100 using the user interface 110 or via a workstation 150. A workstation 150 can communicate with a printing system 100 utilizing a communications network 160. A user profile, work product for printing, media library and print job parameters can be stored in a database 170 or memory also accessible by the workstation 150 or printing system 100 via the network 160, or which can be directly accessed via the printing system 100. A printing system 100 can be improved in accordance with features of the embodiments to include a product to workflow translator module 125 as shown in FIG. 1.

Details of related systems and methods for transforming Product Descriptions into Process Networks can be found in United States Patent Publication No. U.S. Pat. No. 7,406,357 B2, entitled “A Method For Transforming A Product Description Into A Process Network That Specifies How To Create The Product”, issued on Jul. 29, 2008, the disclosure of which is incorporated herein by reference in its entirety.

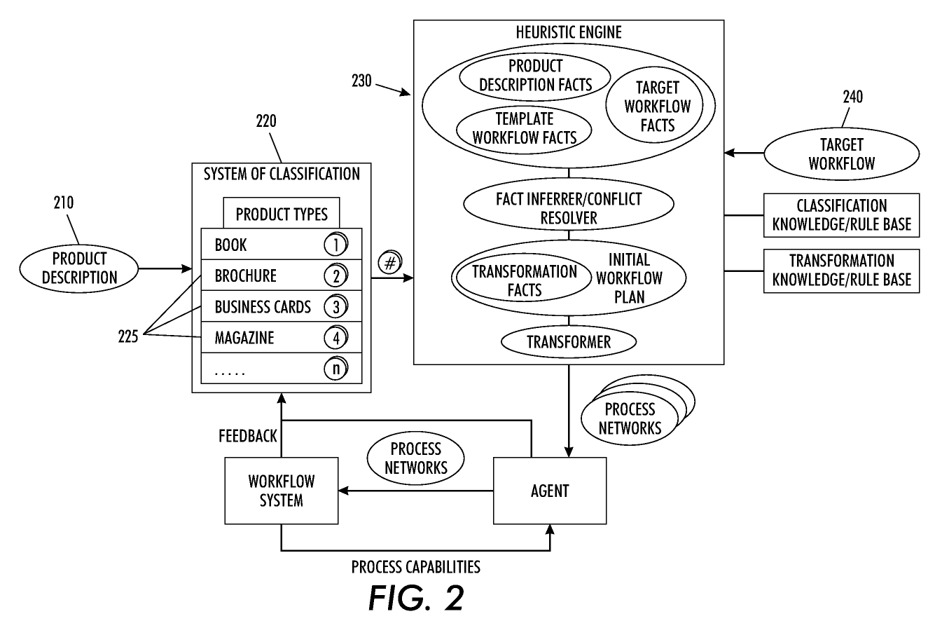

With reference to FIG. 2, which is a block diagram illustrating modules and operations thereof of a workflow automation system for carrying out features of embodiments, transformation of a Product Description 210 to a Process Network 235 consistent with a Target Workflow 240 can be generally outlined as follows. The Product Description 210 can be linked to a set of processing instructions through association of the processing instructions with classes in the common classification system 220. Predefined Workflow Templates 225 representing Process Networks (workflows) can be created and classified into the same product classification system 220 used to classify Product Descriptions. Facts about the desired product to be manufactured can be derived. More specifically, Product Description facts (information) 236 and Template Workflow facts 237 can be collected from the Product Description and Template Workflow, respectively.

A Target Workflow 240 is also identified, when a job is actually submitted, as the workflow to use for the job. The Target Workflow 240 represents processing instructions to create the product, or at least part of it, that are desired when the job is actually submitted which may or may not be consistent with the processing instructions to which the Product Description is already linked through the classification system 220. Target Workflow facts (information) 238 about the provided Target Workflow 240 can also be collected. Transformation facts 271 are facts inferred from the collected, Product Description, Workflow Template and Target Workflow facts. Transformation facts 271 are inferred by evaluation of the collected facts using a transformation knowledge/rule base 251. Transformation facts represent constraints and other information to be used during the actual transformation of the Product Description to the Process Network.

The Transformation facts in these particular examples can be information or data, such as global data, that is not changed or modified by application of rules. However, the Transformation facts can also be information that has been changed or modified by rules or a combination of both unmodified and modified data. Such Transformation facts are used to generate an Initial Workflow Plan 270. The Initial Workflow Plan describes the essential minimum processing steps and processing instructions for those steps.

The Initial Workflow Plan 270 and the collected facts 236 to 238 about the product to be manufactured can then be used to transform the Product Description into a Process Network consistent with the Target Workflow 240.

Modules of the workflow automation system of FIG. 2 including the system classification and Heuristic Engine modules 220, 230 can be implemented in a computer program product comprising computer-usable data carrier storing instructions that, when executed by a computer of the workflow automation system, such as the workflow automation system of FIG. 1, cause the computer to perform methods for transforming Product Descriptions into a Process Network specifying how to create a product according to features of the embodiments described herein. These modules can be run locally on a work station of a workflow automation system, as in the case of the workflow automation system of FIG. 1, or even run from a remote location via a network coupled to the workflow automation system. These modules can be integrated in a single module if needed. These modules need not be implemented entirely in software. At least part of each module can be implemented in hardware. Those skilled in the art would know that there are multiple modes of implementing such modules.

Referring now to the modules of FIG. 2 in more detail, the system of classification module 220 can include access to memory for storing predefined Workflow Templates 225. Each Workflow Template includes at a minimum a description of all the essential processing steps and essential processing instructions for each processing step required to manufacture a product. The classification module 220 is configured to enable a system of classification. Given a vocabulary to describe products and a separate vocabulary to describe the processing required to create the product, a System of Classification can be constructed that can be used to classify both.

Considering that a Product Description must always be transformed into a set of processing instructions in order to actually create the described product, one of the pre-requisites for the automated conversion of intent to process is a well-defined Product Description. As an example: if a waiter takes a customer order, specifically, “ham and swiss on rye with lettuce and mayo.” The waiter delivers the order to the cook who immediately recognizes that this product is a “sandwich.” Since the cook also knows how to create a “sandwich” he has successfully classified the Product Description and process of creating the product to the same class, namely, “sandwich.” Establishing the System of Classification is typically driven by the Product Descriptions since they represent most closely the end product. In a print shop the classes of things could be of the form of a “brochure,” a “book,” “business cards,” etc. An example of a well-defined Product Description language for print related products is JDF Product Intent.

Once the System of Classification is established, predefined Workflow Templates 225 for the various product classes can be created and stored in memory. The Workflow Templates are partially completed Process Network (workflow) specifications for creating a particular product. Each product class in the system of classification may have several templates associated with it, one for each distinct Process Network (workflow) that can be used to create the product.

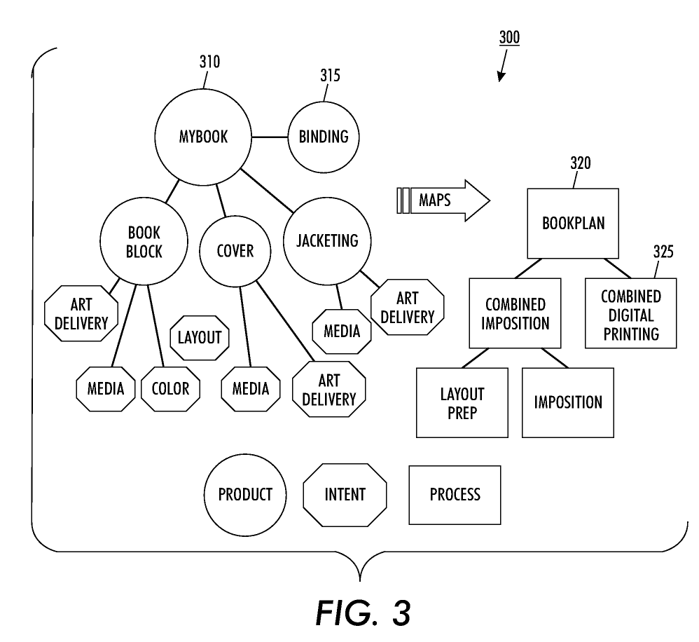

A sample product classification and template 300 referred to as the “MyBook” is illustrated in FIG. 3. The “MyBook” reveals the intent as a binding operation under the Intent Node descriptions tab 315, which is a subcategory to the Product Intent 310 portion of sample 300. Under the Process Template 320 portion of sample 300, a correlating process plan name, “BookPlan”, further specifies the process plan,” under the process node descriptions 325.

The predefined Workflow Templates in a print shop can represent various workflows such as “Imposition+Print+Trim” or “Preflight+Imposition+Print”. Multiple templates with the same process steps could be differentiated by the attributes on a process, such as Imposition producing “portrait” oriented pages in one workflow and “landscape” oriented pages in another workflow.

Insofar as the Target Workflow, this is a workflow that has 1) been previously created on a workflow system to produce something, and 2) is selected at run-time (e.g., during submission of JDF Product Intent. The “product” created by the Target Workflow is explicitly associated with the target workflow when created, at least in the mind of the operator that created the workflow, but is usually implicitly associated with the Target Workflow otherwise. For-example, if an operator creates a workflow to make business cards, the operator knows it is for making business cards, but the operator could name the workflow “favorite workflow.” Now anyone that wants to know what that workflow creates needs to examine it to see what type of product is implicit in the workflow itself.

Referring to the Heuristic Engine 230 shown in FIG. 2, the engine is configured to classify Product Descriptions 210 into a product class in the System of Classification 220 using the classification rule/base 252. Once the Product Description is classified, the set of templates for the class in the System of Classification 220 are selected.

In order for the Heuristic Engine to be more than a one off implementation, a well-defined, extensible method for drawing conclusions based on inferences from a set of facts is preferred. A knowledge/rules based method is appropriate since it is both well-defined and extensible (new or different rules). Facts about the input artifacts are collected (questions are asked) and Rules and/or Knowledge are used to infer conclusions/facts (answers to the questions). In these particular examples, the knowledge/rules based method can draw conclusions using forward chaining rule based inferences. However, other types of inference methods can be adopted. Other methods that satisfy the constraints of well-defined and extensible can also be used. The engine will also need heuristics based on the domain of the specific problem in order to make use of the rules based method. Such heuristics can include aspects of the syntactical constructs used in Product Descriptions or Templates that would be cumbersome to include in the “rules” used to infer conclusions.

The workflow automation system is configured to collect, in the Heuristic Engine 230, facts 236, 237 about the selected Workflow Template 225 and the Product Description 225 relevant to creating a fully specified Process Network that, when executed, will manufacture the product or at least part of it. In addition to collecting the Workflow Template facts 237 and Product Description facts 236 in the Heuristic Engine 230, the workflow automation system is also configured to collect Target Workflow facts 238 in the engine. The Heuristic engine 230 is configured to evaluate the collected facts using a knowledge base 251 to infer transformation facts and, in doing so, resolves any conflicts between the Product Description, Workflow Template and Target Workflow. Examples of the inferred transformation facts are:
(a) Which workflow steps and/or parameters in the Target Workflow can and cannot be overridden by the workflow automation system conversion. For example, the Target Workflow may have entire workflow steps or specific parameter values in a given workflow step that have been flagged as not modifiable
(b) What press-sheet (media) size to use based on the default or required press-sheet (media) sizes specified in the various workflow steps of the Target Workflow along with the finished dimensions (or specified media size) in the JDF Intent.
(c) Whether the workflow automation system default Imposition parameters should be used, or if the Target Workflow Imposition parameters should be used.
(d) Overall consistency between the Target Workflow and the product defined by the JDF Intent. For example, if the JDF Intent specifies a Business Card but the Target Workflow does not have an Imposition step, then there is an inconsistency.

The Heuristic Engine 230 defines an Initial Workflow Plan 270 which represents the transformation facts. Effectively, the Initial Workflow Plan is either 1) the Workflow Template 225, 2) the Target Workflow 240 or 3) a synthesis of the both the Workflow Template and the Target Workflow. The Heuristic Engine 230 is configured to transform the Initial Workflow Plan, using the knowledge base 251 and the collected facts, into the Process Network 235. As the Initial Workflow Plan reflects not only the Workflow Template but also the Target Workflow Plan, the Heuristic Engine 230 effectively transforms the Product Description into a Process Network consistent with the Target Workflow. To this end, Engine 230 applies further knowledge/rule based reasoning to all the collected facts and, in response, fully populates the initial flow work plan to provide the Process Network. If desired, the Engine can combine execution of this further knowledge/rule based reasoning for providing the Process Network with the execution of the aforementioned initial knowledge/rule based reasoning for inferring Transformation Facts from the collected facts. The Process Network is then returned to an agent of the workflow automation system which will execute the Process Network to manufacture the product.

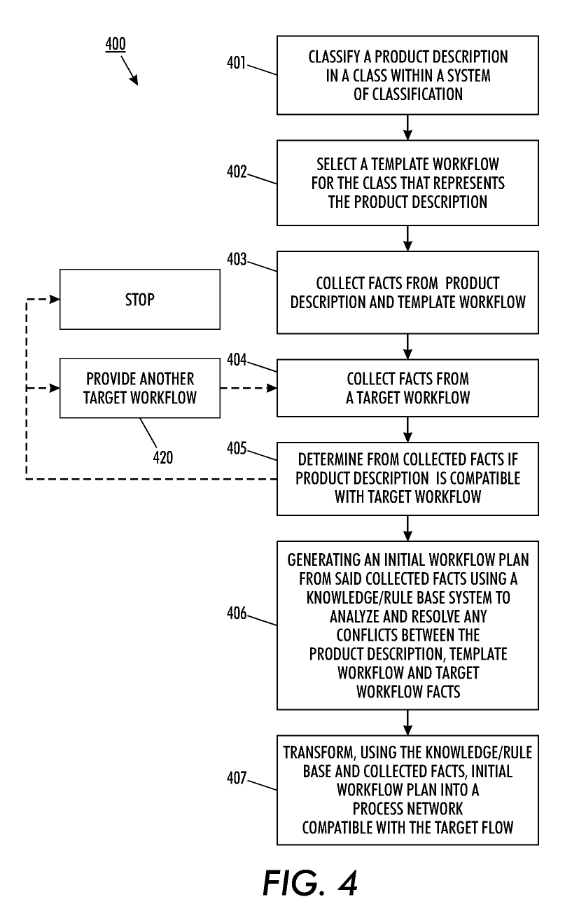

A method 400 for transforming the Product Description into a Process Network specifying how the product can be created in accordance with an embodiment will now be outlined with reference to the flow diagram of FIG. 4 as follows:
Step 401-classify a Product Description in a class within a system of classification
Step 402-select a Workflow Template for the class that represents the Product Description
Step 403-collect facts from Product Description and Workflow Template
Step 404-collect facts from a Target Workflow
Step 405-determine from collected facts if Product Description is compatible with Target Workflow
Step 420-if no, determine another Target Workflow and continue from step 404
Step 406-if yes, generate an Initial Workflow Plan from said collected facts using a knowledge/rule base system to analyze and resolve any conflicts between the Product Description, Workflow Template and Target Workflow facts
Step 407-transform, using the knowledge/rule base and collected facts, Initial Workflow Plan into a Process Network compatible with the Target Workflow

Whilst FIG. 4 indicates the aforementioned sequence of steps 401-407, alternative step sequences may also be adopted. For example, collecting facts from the Product Description and selected Workflow Template (s404) may be implemented prior to collecting facts from a Target Workflow (s403). Also, determining from collected facts if Product Description is compatible with Target Workflow (s405) and providing another target work flow (s420) are optional steps. S405 may be implemented prior to or during generating the Initial Workflow Plan using the knowledge rule/base (s406). Method 400 can for example be implemented in the exemplary workflow automation system having features illustrated in FIGS. 1 & 2.

The system and methods described in this application can be implemented to provide an improved Product Description to Process Network transformation process that considers detailed information from the Target Workflow. The JDF Intent or other type of Product Description can be targeted at a workflow on the workflow automation system which uses information about the Target Workflow during the conversion process. Using the knowledge rule-based system to reconcile differences between what is specified in a Product Description (e.g. JDF Intent) and a Target Workflow in order to produce a workflow to manufacture the print product, allows a Product Description sent to a specific automation system workflow to be transformed into a Process Network that is more likely to be consistent with the user's expectations. The knowledge/rule based system has the ability to infer that the JDF Intent or other type of Product Description is incompatible with the Target Workflow. This enables easy detection of an incompatible Product Description when the Product Description (e.g. JDF intent) is sent to a workflow which would otherwise cause an inconsistency for the workflow system to manufacture the print product.

Method 400 for transforming the Product Description into a Process Network specifying how the product can be created will now be described by way of the following examples 1 to 3. In each example, the method is implemented using a Job Definition Format in a workflow automation system having features of FIGS. 1 and 2. Other format implementations can be used. Also, it is assumed that both the JDF Intent, which is the Product Description, and the Target Workflow, are provided to the Workflow Automation System. These may be submitted to the system for example by an operator of the workflow automation system inputting the information via a user interface. The resulting JDF Process (Process Network) is used by the workflow automation system to manufacture the product.

### EXAMPLE 1

A client submits a JDF Intent (210) specifying 270 copies of a 3.5″×2″ Business Card to a Workflow Automation System. The client can be either a person/operator or an automaton fulfilling the role of an operator. Specifically the JDF Intent is targeted at a workflow on the Workflow Automation System that calls for 3×9 Imposition on 12″×18″ Media followed by Printing. Further, the Imposition step cannot be altered by a transformation process since the “Always use these settings” button is checked for that workflow step.

The System of Classification module 220 classifies the JDF intent (s401) as a class within the System of Classification. The module 220 selects a Workflow Template 225 for the class that represents the JDF intent (s402).

The workflow automation system collects facts 236, 237 from the JDF Intent and selected Workflow Template 225 (s403). The facts collected include: (a) The Finished Dimensions are 3.5″×2″, (b) The Number Of Copies is 270, (c) The Number Of Pages is 2, (d) Additional facts are inferred for the product type (in this case a Business Card), such as: (i) Multi-up Imposition is required, (ii) The Workflow Template Imposition is: 2×5 multi-up imposition on 8.5″×11″ media.

The workflow automated system also collects facts 238 from the Target Workflow (s404). The facts collected include: (a) The Target Workflow consists of Imposition followed by Printing (b) The Default Target Workflow Imposition is: 3×9 multi-up imposition on 12″×18″ media, (c) The Default Target Workflow Imposition step cannot be overridden, (d) The Default Target Workflow Printing step may be overridden.

The facts collected from the JDF Intent and Target Workflow are asserted in the working memory of a knowledge/rule-based system, which in the example of FIG. 2, is the Heuristic Engine 230 in conjunction with the Transformation/Rule base 251. The knowledge rule-based system then analyzes the two sets of facts and infers new transformation facts 271 which form an Initial Workflow Plan 270 that will be used during the rule-based transformation of JDF Intent into JDF Process (Process Network). The Fact Inferrer/Conflict Resolver 255 component of the Heuristic Engine, with the help of the transformation Knowledge/Rule base, analyzes and resolves any conflicts between the Product Description, Workflow Template and Target Workflow facts and generates the Initial Workflow Plan (s406).

In this particular example, the Heuristic Engine 230, whilst analyzing the collected facts, determines that the JDF Intent is compatible with the Target Workflow (s405).

Specifically, in the present example, the following transformation inferences are made: (a) The Default Target Workflow Imposition step cannot be overridden so use it as the fully parameterized Imposition step in the resulting JDF Process, (b) Since the Default Target Workflow Imposition step cannot be overridden and the Printing step can be overridden, use the Media size from the Default Target Workflow Imposition step as the press-sheet (media) size for the Printing step. (c) The essential required minimum processing steps are Imposition followed by Printing. These transformation facts make up the initial work flow plan.

The generated Initial Workflow Plan 270 together with the JDF Intent facts and the Target Workflow facts collected in steps (s403) and (s404), respectively, are used by the Heuristic Engine 230, in particular the transformer component 273, to transform the JDF Intent into a JDF Process (Process Network) as follows: (a) Parameterize the Impose node with information provided by the Target Workflow (press sheet size 12×18, 3×9 multi-up, etc . . . ); and (b) Parameterizes the Print node: (i) Use media size (press sheet size) specified in the Impose node as the media size; (ii) Set copy count to 270. The process then returns to the JDF process flow to manufacture the business card according to the JDF process.

### EXAMPLE 2

A client submits a JDF Intent representing 1000 copies of a 4″×6″ Post Card to the Workflow Automation System. Specifically the JDF Intent is targeted at a workflow on the workflow automation system that calls for 3×3 Imposition on 12″×18″ Media followed by Printing. Further, neither the Imposition nor Printing steps have the “Always use these settings” button checked.

The System of Classification module 220 classifies the JDF intent (s401) as a class within the System of Classification. The module 220 selects a Workflow Template 225 for the class that represents the JDF intent (s402).

The workflow automation system collects facts from the JDF Intent and selected Workflow Template (s403). The facts collected include: (a) The Finished Dimensions are 4″×6″, (b) The Number Of Copies is 1000, (c) The Number Of Pages is 2, (d) Additional facts are inferred for the product type (in this case a Post Card), such as: (i) Multi-up Imposition is required, (ii) The Workflow Template Imposition is: 2×2 multi-up imposition on 17″×11″ media.

The workflow automation system collects facts from the Target Workflow (s404), The facts collected include: (a) The Target Workflow consists of Imposition followed by Printing, (b) The Default Target Workflow Imposition is: 3×3 multi-up imposition on 12″×18″ media, (c) The Default Target Workflow Imposition step may be overridden, and (d) The Default Target Workflow Printing step may be overridden.

The facts collected from the JDF Intent and Target Workflow are asserted in the working memory of the Knowledge/rule-based system, which in this example is the Heuristic Engine 230 of FIG. 2 in conjunction with the Knowledge/rule base 251. The knowledge/rule-based system then analyzes the two sets of facts and infers new transformation facts 271 that form an Initial Workflow Plan 270 and that will be used during the rule-based transformation of JDF Intent into JDF Process (s406). Specifically the following inferences are made: (a) The Default Target Workflow Imposition step may be overridden, (b) Since the finished dimensions of the product specified in the JDF Intent are 4″×6″ and since these dimensions will fit into a 3×3 grid on 12″×18″ media, the Default Target Workflow Imposition will be used instead of the Workflow Template imposition, and (c) Since the Default Target Workflow Imposition is being used and since the Printing step may be overridden, the Media size from the Default Target Workflow Imposition step will be used as the press-sheet (media) size for the Printing step.

The inferred transformation facts 271 in the form of the Initial Workflow Plan 270, the JDF Intent facts previously collected (see S403) and the previously collected Target Workflow facts (see s404) are used in a rule-based system to transform the JDF Intent into JDF Process: (a) Parameterize the Impose node with information Target Workflow (press sheet size 12×18, 3×3 multi-up, etc . . . ), (b) Parameterizes the Print node: (i) Use media size (press sheet size) specified in Impose node as the media size, namely, 12×18, and (ii) Set copy count to 1000. Return to the JDF Process.

### EXAMPLE 3

A client submits a JDF Intent representing 1000 copies of a 4″×6″ Post Card to the Workflow Automation System. Specifically the JDF Intent is targeted at a Target Workflow that calls for 3×3 Imposition with ½″ gutter on 12″×18″ Media followed by Printing. Further, neither the Imposition nor Printing steps have the “Always use these settings” button is checked. This example differs from example 2 only in that the default Target Workflow imposition includes ½″ gutter not present in example 2.

The System of Classification module 220 classifies the JDF intent (s401) as a class within the System of Classification. The module 220 selects a Workflow Template 225 for the class that represents the JDF intent (s402).

The workflow automation system collects facts from the JDF Intent and the selected Workflow Template (see s403). The facts collected include: (a) The Finished Dimensions are 4″×6″, (b) The Number Of Copies is 1000, (c) The Number Of Pages is 2, (d) Additional facts are inferred by the product type (in this case a Post Card), such as: (i) Multi-up Imposition is required, (ii) The Workflow Template Imposition is: 2×2 multi-up imposition on 17″×11″ media.

The workflow automation system collects facts from the Target Workflow (s404). The facts collected include: (a) The Target Workflow consists of Imposition followed by Printing, (b) The Default Target Workflow Imposition is: 3×3 multi-up imposition with ½″ gutter on 12″×18″ media, (c) The Default Target Workflow Imposition step may be overridden, (d) The Default Target Workflow Printing step may be overridden.

The facts collected from the JDF Intent and Target Workflow are asserted in the working memory of a rule-based system. The knowledge rule-based system then analyzes the two sets of facts and infers new transformation facts to form an Initial Workflow Plan that will be used during the rule-based transformation of JDF Intent into JDF Process (s406). Specifically the following inferences are made: (a) The Default Target Workflow Imposition step may be overridden, (b) Since the finished dimensions of the product specified in the JDF Intent are 4″×6″ and since these dimensions will NOT fit into a 3×3 grid with ½″ gutter on 12″×18″ media, the Workflow Template Imposition will be used instead of the default Target Workflow imposition, and (c) Since the Workflow Template Imposition is being used and since the Printing step may be overridden, the Media size from the Default I2P Workflow Imposition step will be used as the press-sheet (media) size for the Printing step.

The transformation facts 271 in the form of the Initial Workflow Plan 270, the previously collected JDF Intent facts and previously collected Target Workflow facts are used in the knowledge/rule-based system to transform the JDF Intent into JDF Process: (a) Parameterize the Impose node with information from the Intent2Process default imposition for Post Cards (press sheet size 17×11, 3×3 multi-up, etc . . . ), (b) Parameterizes the Print node: (i) Use media size (press sheet size) specified in Impose node as the media size, namely, 17×11, (ii) Set copy count to 1000. Return the JDF Process.

A JDF process, such as for example a resulting JDF process from the aforementioned example 1, 2 or 3, can be used by the workflow automation system to manufacture the product. The rules for executing JDF Process (a Workflow Plan) against the Target Workflow are:

If the JDF Process specifies workflow steps that can be executed by the Target Workflow:

Each workflow step in a pre-defined automation system workflow has an “Always use these settings” option that may be “on” or “off”.
i. When “Always use these settings” is “on” the pre-defined workflow step is always used as defined.
ii. When “Always use these settings” is “off” then the JDF Process (Workflow Plan) is examined to see if a corresponding workflow step exists:
   1. If a corresponding workflow step does exist in the JDF Process, then the workflow step in the JDF Process is used as defined.
   2. If a corresponding workflow step does NOT exist in the JDF Process, then the pre-defined workflow step in the Target Workflow is used as defined.

If the JDF Process specifies workflow steps that cannot be executed by the Target Workflow, then the job is failed and a message is provided to the operator to send the job to a different Target Workflow.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

The claims can encompass embodiments in hardware, software, or a combination thereof. The word “printer” as used herein encompasses any apparatus, such as a digital copier, bookmaking machine, facsimile machine, multifunction machine, etc. which performs a print outputting function for any purpose.

1. A system for transforming a Product Description into a Process Network specifying how to create a product, comprising:
a common Classification System linking Product Descriptions and processing instructions required to create a product;
at least one predefined Workflow Template comprising partially completed Process Network specifications for creating a product;
a Target Workflow comprising a pre-defined workflow provided as the workflow to use to create the product; and
a Knowledge/Rule Based System,
wherein said Knowledge/Rule Base System is configured to classify at least one Product Description into a product class in the common classification system, collect facts from the classified Product Description, Workflow Template and Target Workflow; generate an Initial Workflow Plan from said collected facts by analyzing and resolving any conflicts between the collected Product Description, Workflow Template and Target Workflow facts; and transform said Initial Workflow Plan into a Process Network specifying how to create at least part of a product defined by the Product Description that is consistent with said Target Workflow.

2. The system of claim 1, wherein said product comprises a print product, wherein said Product Description comprises a print Product Description and wherein said Process Network comprises a print Process Network specifying how to create at least part of a print product.

3. The system of claim 1, wherein said Knowledge/Rule Base System is further configured to determine from said collected facts if said Product Description is incompatible with said Target Workflow.

4. The system of claim 1, wherein said Product Description comprises a JDF intent and wherein said Process Network comprises a JDF process.

5. The system of claim 1 wherein said Product Description includes a description associated with product binding.

6. The system of claim 1 wherein said Product Description includes a description associated with product color and/or layout.

7. The system of claim 1 wherein said Knowledge/Rule Base System comprise a Heuristic Engine operably connected to a Knowledge/Rule Base.

8. A method for transforming Product Descriptions into a Process Network specifying how to create a product, comprising
classifying a Product Description in at least one class within a System of Classification;
selecting a Workflow Template for said at least one class that represents said Product Description;
providing a Target Workflow comprising a pre-defined workflow to use to create the product;
collecting facts from said Product Description, Workflow Template and Target Workflow;
generating an Initial Workflow Plan from said collected facts using a Knowledge/Rule Base System; said Knowledge/Rule Base System analyzing, and resolving any conflicts between, the Product Description, Workflow Template and Target Workflow facts in order to generate said Initial Workflow Plan;
transforming, using said Knowledge/Rule Base System and said collected facts, said Initial Workflow Plan into a Process Network specifying how to create at least part of a product defined by the Product Description that is consistent with said Target Workflow.

9. The method of claim 8, wherein said Product Description comprises a print Product Description and wherein said Process Network comprises a print Process Network specifying how to create at least part of a print product.

10. The method of claim 8, further comprising determining from said collected facts using said Knowledge/Rule Base System that said Product Description is incompatible with said Target Workflow.

11. The method of claim 10, further comprising providing another Target Workflow in response to determining said Product Description is incompatible with said Target Workflow; and using said another Target Workflow in said method for transforming said Product Description into a Process Network specifying how to create at least part of a product consistent with said another Target Workflow.

12. The method of claim 8, wherein said Product Description comprises a JDF intent and wherein said Process Network comprises a JDF process.

13. A computer program product comprising:
a computer-usable data carrier storing instructions that, when executed by a computer, cause the computer to perform a method comprising a method for transforming Product Descriptions into a Process Network specifying how to create a product, comprising
classifying a Product Description in at least one class within a System of Classification;
selecting a Workflow Template for said at least one class that represents said Product Description;
providing a Target Workflow comprising a pre-defined workflow to use to create the product;
collecting facts from said Product Description, Workflow Template and Target Workflow;
generating an Initial Workflow Plan from said collected facts using a Knowledge/Rule Base System; said Knowledge/Rule Based System analyzing, and resolving any conflicts between, the Product Description, Workflow Template and Target Workflow facts in order to generate said Initial Workflow Plan;
transforming, using said Knowledge/Rule Base System and said collected facts, said Initial Workflow Plan into a Process Network specifying how to create at least part of a product defined by the Product Description that is consistent with said Target Workflow.

14. The method of claim 13, wherein said Product Description comprises a print Product Description and wherein said Process Network comprises a print Process Network specifying how to create at least part of a print product.

15. The method of claim 13, further comprising determining from said collected facts using said Knowledge/Rule Base System that said Product Description is incompatible with said Target Workflow.

16. The method of claim 13, further comprising providing another Target Workflow in response to determining said Product Description is incompatible with said Target Workflow; and using said another Target Workflow in said method for transforming said Product Description into Process Network specifying how to create at least part of a product consistent with said another Target Workflow.

17. The method of claim 13, wherein said Product Description comprises a JDF intent and wherein said Process Network comprises a JDF process.

18. The method of claim 13, wherein said Knowledge/Rule Base System comprises a Heuristic Engine operably connected to a Knowledge/Rule Base.

19. The method of claim 13, wherein said Product Description comprises a print Product Description and wherein said Process Network comprises a print Process Network specifying how to create at least part of a print product.
